(19) United States
(12) Patent Application Publication
(10) Pub. No.: US 2011/0025279 A1
(43) Pub. Date: Feb. 3, 2011

(54) POWER SUPPLY CIRCUIT AND SEMICONDUCTOR DEVICE

(75) Inventors: TOSHIKATSU JINBO, Kanagawa (JP); Tetsuo Fukushi, Kanagawa (JP); Kazutaka Kikuchi, Kanagawa (JP)

Correspondence Address: FOLEY AND LARDNER LLP;SUITE 500, 3000 K STREET NW, WASHINGTON, DC, 20007, US

(73) Assignee: NEC Electronics Corporation

(21) Appl. No.: 12/821,955

(22) Filed: Jun. 23, 2010

(30) Foreign Application Priority Data
Jul. 29, 2009 (JP) 2009-176680

(51) Int. Cl. G05F 1/10

(52) U.S. Cl. 323/234

(57) ABSTRACT

A power supply circuit comprises: a first voltage booster circuit that receives a first clock signal having a fixed frequency, and supplies a voltage to a prescribed circuit; and a second voltage booster circuit that receives a second clock signal having a frequency corresponding to an operating frequency of the prescribed circuit, and supplies a voltage to the prescribed circuit.

### TECHNICAL FIELD

### Reference to Related Application

This application is based upon and claims the benefit of the priority of Japanese Patent Application No. 2009-176680, filed on Jul. 29, 2009, the disclosure of which is incorporated herein in its entirety by reference thereto.

The present invention relates to a power supply circuit and a semiconductor device, and in particular, to a power supply circuit that boosts voltage, by a voltage booster circuit, of a power supply supplied from outside, and supplies the power supply as an internal power supply to an internal circuit of the semiconductor device, and relates to a semiconductor device provided with the power supply circuit in question.

### BACKGROUND

Through the miniaturization of transistors that make up semiconductor devices, integration of the semiconductor devices increases and chip sizes shrink, so that reductions in cost become possible.

Along with the miniaturization of transistors, from the viewpoint of reliability, a need has arisen to lower the voltage of power supply voltages applied to circuits that make up the semiconductor devices. Accompanying this, power supply voltages supplied from outside also have their voltages lowered.

Besides logic circuits, a DRAM may also be implemented as internal memory in the semiconductor devices. In general, when data is written to and read from a DRAM cell, it is necessary to apply a relatively high voltage to a gate of a memory cell transistor. Therefore, in a case where the power supply voltage supplied from outside of the semiconductor device has its voltage lowered, it is necessary to generate a high voltage internally in the semiconductor device, for example, by a power supply circuit that includes a voltage booster circuit.

FIG. 6 is a block diagram showing a configuration of the semiconductor device in which the DRAM cell is implemented. Referring to FIG. 6, the semiconductor device 20 has a power supply circuit 21, a DRAM 22, and a logic circuit 23.

An external power supply VDD (for example, 1.5 V) is supplied to the logic circuit 23, and together with the external power supply VDD, a VPP (for example, 2.5 V), whose voltage is boosted by a power supply circuit, is supplied to the DRAM 22. CLK, which is an external clock, together with a command and address for controlling operation are inputted to the logic circuit 23 and the DRAM 22, and data input and output are performed.

FIG. 12 is a block diagram showing a configuration of a power supply circuit including a voltage booster circuit, described in Patent Document 1. Referring to FIG. 12, the power supply circuit has the voltage booster circuit, a clock generation circuit, and a high voltage detection circuit.

Next, referring to FIG. 7 to FIG. 10, a description is given concerning configuration, characteristic, and operation of a conventional power supply circuit that includes a voltage booster circuit.

FIG. 7 is a block diagram showing a configuration of the conventional power supply circuit 21 that includes a voltage booster circuit. Referring to FIG. 7, a power supply circuit 21 has the voltage booster circuit 111, a high voltage detection circuit 116, an internal clock generation circuit 115, and a NAND circuit NAND11.

FIG. 8 shows, as an example, a specific circuit diagram of the voltage booster circuit 111 included in the conventional power supply circuit 21. Referring to FIG. 8, the voltage booster circuit 111 has n-type MOSFETs MN0 to MN2, capacitive elements C1 and C2, and inverters IN1 to IN3.

In the voltage booster circuit 111, the n-type MOSFETs MN0 to MN2 are diode-connected in series, and the capacitive elements C1 and C2 are connected to junctions thereof. Clock signals PCLA and PCLB are received respectively at opposite electrodes of the capacitive elements C1 and C2. The inverter IN1 receives the clock signal PCL, and outputs the clock signal PCLA. The inverters IN2 and IN3 that are connected in series receive the clock signal PCL, and output the clock signal PCLB. The clock signals PCLA and PCLB are complementary signals.

By the clock signal PCL being received, charge is sequentially transferred from VDD to VPP via the n-type MOSFETs MN0 to MN2 that are connected in series, and a high voltage is supplied to VPP.

In the voltage booster circuit 111 shown in FIG. 8, the n-type MOSFETs MN0 to MN2 in three stages are connected in series. Changing the number of stages of the MOSFETs, optimizing the size of each MOSFET and each of the capacitive elements, and setting the frequency of the clock signal PCL, in accordance with the level of the external power supply VDD, the level of the VPP that is necessary, and required current supply capability, are design matters.

FIG. 9A is a characteristic diagram showing current supply capability of the voltage booster circuit 111. The horizontal axis of FIG. 9A represents frequency of the clock signal of the voltage booster circuit 111, and the ordinate represents VPP current supply capability of the voltage booster circuit 111. FIG. 9B shows consumption current in a case where the VPP is supplied to the DRAM 22, in the semiconductor device 20 shown in FIG. 6. The abscissa of FIG. 9B represents operating frequency of the DRAM 22, and the ordinate represents the VPP current consumed by the DRAM 22.

Referring to FIG. 9A, a description is given concerning characteristic of the voltage booster circuit 111. Current supply capability changes according to the size of the capacitive elements C1 and C2 and the current characteristic of the transistors MN0 to MN2 that make up the voltage booster circuit 111. In general, in accordance with the frequency of the clock signal being made a high frequency, the current supply capability is improved. However, if the frequency of the clock signal goes above a prescribed frequency, the current supply capability saturates. This is because, above the prescribed frequency, in each period of the clock, charge is not transferred sufficiently.

Referring to FIG. 9A, in a case where the frequency of the clock signal exceeds a frequency PC, the current supply capability saturates. Therefore, to raise the current supply capability (for example, IPPmax), the voltage booster circuit 111 is preferably operated at the frequency PC.

Next, referring to FIG. 9B, a description is given concerning a characteristic of the DRAM 22 that consumes the current. The VPP consumption current of the DRAM 22 includes a DC current component that flows as a DC current due to an off-leak of the transistor even in a state where the DRAM 22 is not operating, and an AC current component that changes in accordance with operating frequency and flows as an AC current.

Referring to FIG. 9B, the DRAM 22 consumes a current of IPP1 when the operating frequency is at frequency DC1, and when the operating frequency is at frequency DC2, which is a higher frequency than the frequency DC1, the AC current component is increased, and a current of IPP2 is consumed.

With regard to the DRAM 22 showing the VPP consumption current characteristic of FIG. 9B, in a case of guaranteeing operation in a range from the frequency DC1 to the frequency DC2, the voltage booster circuit 111 is operated at a frequency of PC in FIG. 9A. In this case, the VPP current supply capability is IPPmax, and it is possible to guarantee operation with a margin with respect to the VPP consumption current IPP2 at the high frequency DC2. Therefore, the internal clock generation circuit 115 is designed so as to oscillate the clock at the frequency PC.

FIG. 10 is a voltage waveform diagram showing operation of a conventional power supply circuit 21. Referring to FIG. 10, a description is given of operation of the abovementioned power supply circuit 21 in a case where the DRAM 22 operates at an operating frequency DC2.

A DRAM access waveform in FIG. 10 represents a cycle of data writing and reading operations with respect to the DRAM 22. The DRAM 22 consumes current of VPP in this operation cycle, and consumes current IPP2 shown in FIG. 9B. CLB, PCL, and PACT in FIG. 10 respectively represent output waveforms of the internal clock generation circuit 115, the NAND circuit NAND11, and the high voltage detection circuit 116 shown in FIG. 7.

As an example, assume that a set level of VPP is 2.5 V. Since at time T0 the VPP level is lower than a prescribed level, the output PACT of the high voltage detection circuit 116 is outputted at an H level. Since PACT is at the H level, the NAND circuit NAND11 supplies the clock signal (pumping pulse) PCL to the voltage booster circuit 111, synchronized with the clock CLB. In this way, the voltage booster circuit 111 performs a voltage boosting operation and a high voltage is supplied to the VPP.

As shown in FIG. 9A, since the frequency of the clock signal is a frequency PC, the current supply capability IPPmax of the voltage booster circuit 111 is larger than the consumption current IPP2. Therefore, the level of the VPP gradually increases, and is 2.5 V at time T1. In consideration of delay time required for judgment of voltage by the high voltage detection circuit 116, the output PACT of the high voltage detection circuit 116 transitions to an L level at time T2. Thereupon, the output PCL of the NAND circuit NAND11 is fixed at the H level, and the voltage booster circuit 111 stops the voltage boosting operation.

After this, the level of the VPP decreases due to operation of the DRAM 22, and amounts to less than 2.5 V after time T3. In consideration of the delay time required for judgment of voltage by the high voltage detection circuit 116, the output PACT of the high voltage detection circuit 116 transitions to an H level at time T4. Thereupon, the output PCL of the NAND circuit NAND11 is synchronous with the clock signal CLB. At this time, the clock signal PCL is supplied to the voltage booster circuit 111, and the voltage booster circuit 111 performs a voltage boosting operation and supplies a high voltage to the VPP.

By repeating the above operation, the VPP level is controlled to be in a vicinity of 2.5 V, which is a target value.

### [Patent Document 1]

JP Patent Kokai Publication No. JP-P2006-185530A (FIG. 4)

### SUMMARY

The entire disclosure of Non-Patent Document 1 is incorporated herein by reference thereto.

The following analysis is given by the present inventors.

In the abovementioned description, the frequency of a clock signal CLB, oscillated by an internal clock generation circuit 115 is set to a frequency PC. On the other hand, a DRAM 22 of a semiconductor device 20 shown in FIG. 6 generally operates in synchronization with an external clock CLK.

The frequency of the external clock CLK may have different values depending on a system in which the semiconductor device 20 is mounted. Therefore, as shown in FIG. 9B, in a range from DC1, which is a low frequency, to DC2, which is a high frequency, it is necessary to guarantee operation of the DRAM 22.

In order to guarantee a consumption current IPP2 of the DRAM 22, at the high frequency DC2 at which consumption current is higher, the VPP current supply capability of the power supply circuit 21, which supplies VPP, is designed to be IPPmax. Thus, in a case where the DRAM 22 operates at the low frequency DC1, control with regard to a high voltage side of the VPP becomes difficult, and as described below, there is a problem in that the VPP shifts largely to a high voltage side, and reliability of a device to which the VPP is applied decreases.

FIG. 11 is a voltage waveform diagram showing operation of a power supply circuit 21. In comparison to FIG. 10, FIG. 11 shows a case where the period of access for the DRAM 22 is double, and the DRAM 22 operates at a frequency of DC1 in FIG. 9B.

As an example, a set level of VPP is 2.5 V, similar to FIG. 10. Since at time T0 the VPP level is lower than a prescribed level, the output PACT of the high voltage detection circuit 116 is outputted at an H level. Since PACT is at the H level, output PCL of the NAND circuit NAND11 supplies a pumping pulse PCL to the voltage booster circuit 111, synchronized with the clock CLB. In this way, the voltage booster circuit 111 operates and a high voltage is supplied to the VPP.

As shown in FIG. 9A, since the frequency of the clock signal is a frequency PC, the current supply capability IPPmax of the voltage booster circuit 111 is larger than the consumption current IPP1. Therefore, the level of the VPP gradually increases, and at time T1 is 2.5 V. As a delay time required for judgment of the voltage by the high voltage detection circuit 116, a delay time approximately the same as FIG. 10 is necessary.

In a time-period from time T1 to time T2, the VPP has an excessive voltage boost. A difference between the VPP current supply capability IPPmax of the voltage booster circuit and the current IPP1 actually consumed (IPPmax−IPP1) in a case where the operating frequency of the DRAM 22 is DC1, is very large in comparison to a difference between the VPP current supply capability IPPmax of the voltage booster circuit and the current IPP2 actually consumed (IPPmax−IPP2) in a case where the operating frequency of the DRAM 22 is DC2 (refer to FIG. 9A).

Therefore, the amount of excessive voltage boost of the VPP to a high voltage between time T1 and time T2 in FIG. 11 is large in comparison to a case shown in FIG. 10. In this way, if the VPP has an excessive voltage boost, there is a problem in that reliability of a device supplied by the VPP decreases.

Therefore, there is a need in the art to change the current supply capability of a power supply circuit, in accordance with the amount of current consumed by a circuit supplied with current by the power supply circuit, is a problem. There is also a need to provide a power supply circuit and a semiconductor device that solve this problem.

In a first aspect of the present invention, there is provided a power supply circuit comprising:

a first voltage booster circuit that receives a first clock signal having a fixed frequency, and supplies a voltage to a prescribed circuit; and
a second voltage booster circuit that receives a second clock signal having a frequency corresponding to an operating frequency of the prescribed circuit, and supplies a voltage to the prescribed circuit.

In a second aspect of the present invention, there is provided a semiconductor device comprising the power supply circuit.

The present invention provides the following advantage, but not restricted thereto.

According to the power supply circuit and the semiconductor device of the present invention, it is possible to change the current supply capability of the power supply circuit, in accordance with amount of current consumed by a circuit supplied with current by the power supply circuit.

### BRIEF DESCRIPTION OF THE DRAWINGS

FIG. 1 is a block diagram showing a configuration of a power supply circuit according to a first exemplary embodiment.

FIG. 2A is a characteristic diagram showing VPP current supply capability of a voltage booster circuit making up a power supply circuit according to a first exemplary embodiment.

FIG. 2B is a characteristic diagram showing VPP current consumed by DRAM, according to a first exemplary embodiment.

FIG. 3 is a voltage waveform diagram showing operation of a power supply circuit according to a first exemplary embodiment.

FIG. 4 is a voltage waveform diagram showing an operation of a power supply circuit according to a first exemplary embodiment.

FIG. 5 is a block diagram showing a configuration of a power supply circuit according to a second exemplary embodiment.

FIG. 6 is a block diagram showing a configuration of a semiconductor device in which a DRAM cell is implemented.

FIG. 7 is a block diagram showing a configuration of a conventional power supply circuit.

FIG. 8 is a circuit diagram of a voltage booster circuit included in a conventional power supply circuit.

FIG. 9A is a characteristic diagram showing VPP current supply capability of a conventional voltage booster circuit.

FIG. 9B is a characteristic diagram showing VPP current consumed by a DRAM.

FIG. 10 is a voltage waveform diagram showing operation of a conventional power supply circuit.

FIG. 11 is a voltage waveform diagram showing the operation of a conventional power supply circuit.

FIG. 12 is a block diagram showing a configuration of a power supply circuit including a voltage booster circuit, described in Patent Document 1.

### PREFERRED MODES

In the present disclosure, there are various possible modes, which include the following, but not restricted thereto.

A power supply circuit in a first mode is preferably a power supply circuit according to the first aspect.

A power supply circuit in a second mode may further comprise a high voltage detection circuit that detects a voltage supplied to a prescribed circuit by a first voltage booster circuit and a second voltage booster circuit, and in a case where the voltage in question is larger than a prescribed threshold voltage, stops a voltage boosting operation in the first voltage booster circuit and the second voltage booster circuit.

A power supply circuit in a third mode may further comprise an internal clock generation circuit that generates a first clock signal.

In the power supply circuit in a fourth mode, the first voltage booster circuit may output a direct current component in current consumed by the prescribed circuit, and the second voltage booster circuit may output an alternating current component in current consumed by the prescribed circuit.

A power supply circuit in a fifth mode may further comprise a frequency multiplier circuit that receives a clock signal having an operating frequency of the prescribed circuit, and multiply the frequency, which is outputted as the second clock signal.

A power supply circuit in a sixth mode may further comprise a frequency divider circuit that receives a clock signal having an operating frequency of the prescribed circuit, and performs frequency division on the frequency, which is outputted as the second clock signal.

A power supply circuit in a seventh mode may comprise the abovementioned power supply circuit.

A power supply circuit in an eighth mode may further comprise the prescribed circuit.

### First Exemplary Embodiment

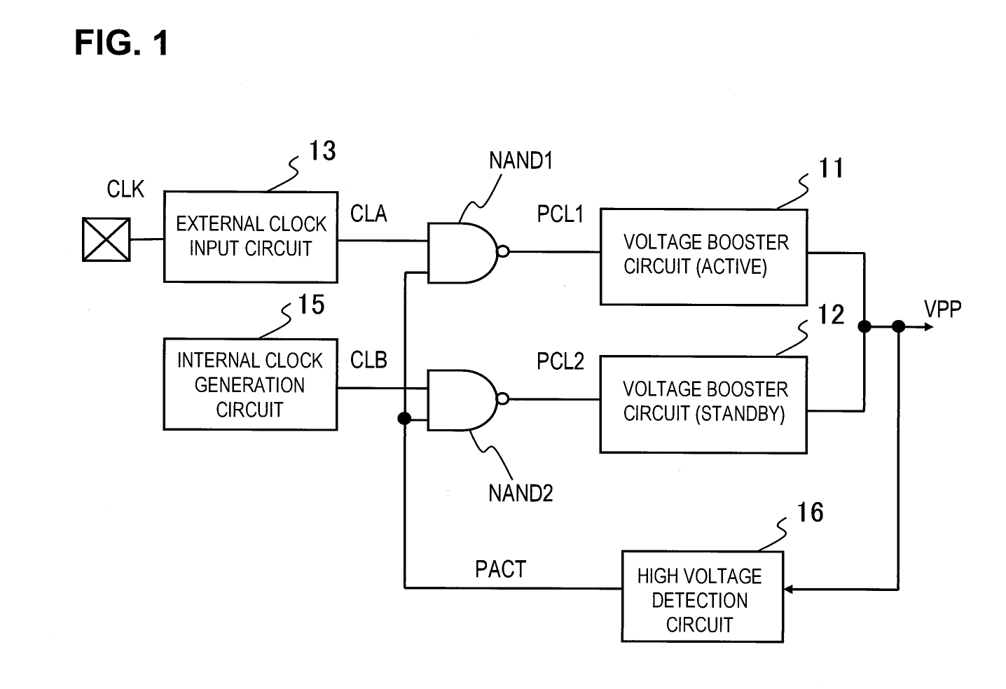

A description is given concerning a power supply circuit according to a first exemplary embodiment, making reference to the drawings. FIG. 1 is a block diagram showing a configuration of the power supply circuit according to the present exemplary embodiment. Referring to FIG. 1, the power supply circuit has voltage booster circuits 11 and 12, a high voltage detection circuit 16, an external clock input circuit 13, an internal clock generation circuit 15, and NAND circuits NAND1 and NAND2.

The voltage booster circuit 11 supplies an AC current component of a circuit to which VPP is supplied. The high voltage detection circuit 16 judges the VPP level, and controls an output signal PACT. The external clock input circuit 13 receives an external clock CLK, and outputs as a clock signal CLA. The NAND circuit 1 receives the clock signal CLA and the signal PACT as input, and outputs the signal PCL1. The voltage booster circuit 11 receives the signal PCL1.

On the other hand, the voltage booster circuit 12 supplies a DC current component of the circuit to which VPP is supplied. The NAND circuit 2 receives the signal PACT and the clock signal CLB outputted by the internal clock generation circuit 15, and outputs the signal PCL2. The voltage booster circuit 12 receives the signal PCL2.

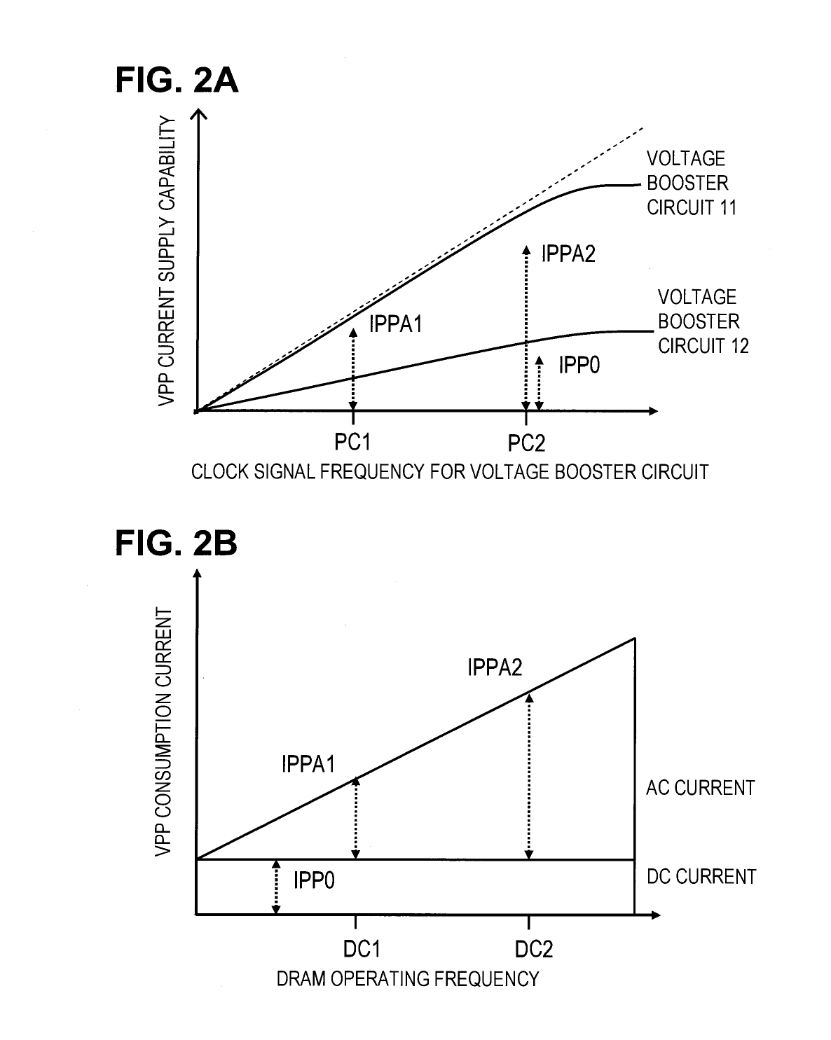

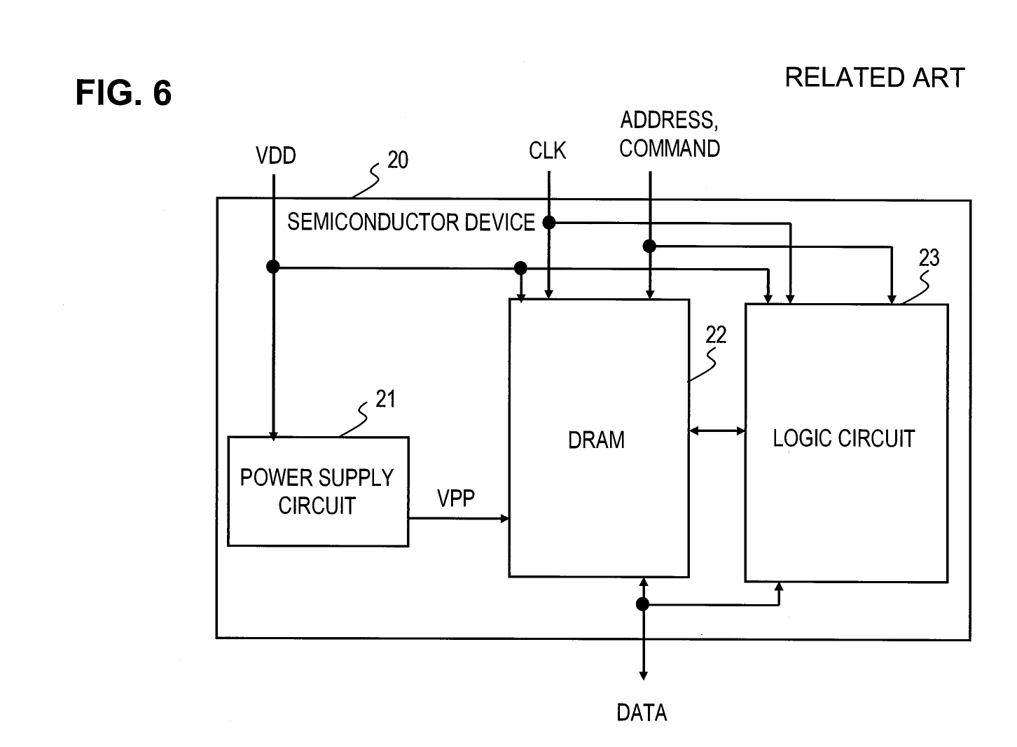

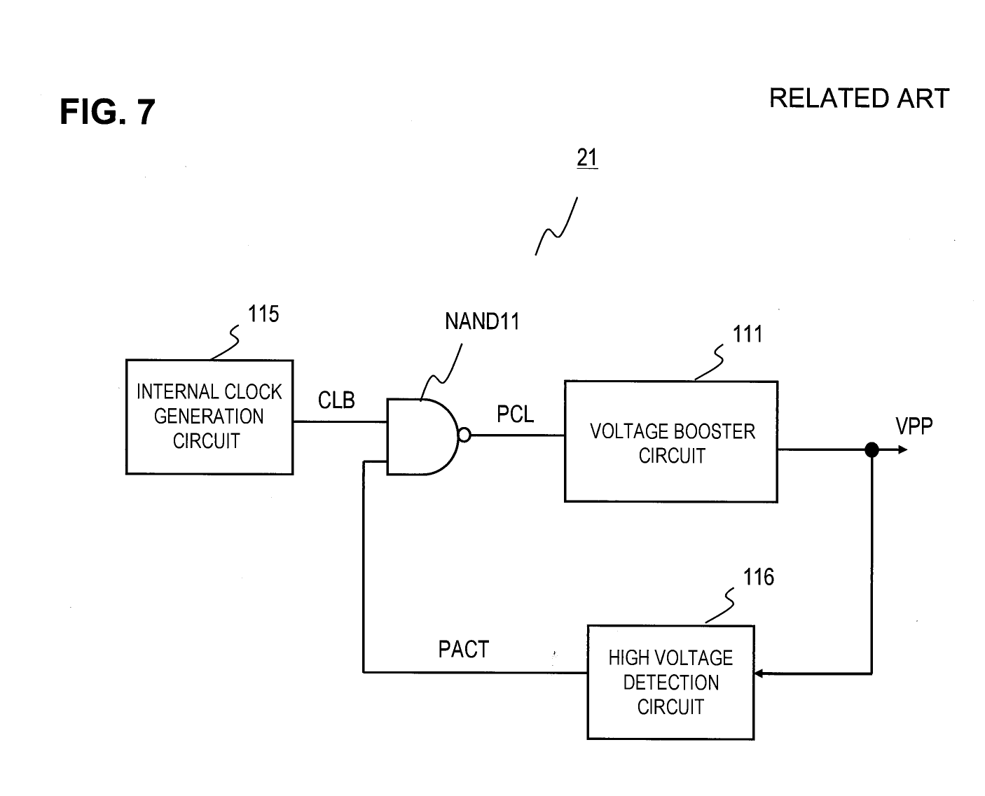

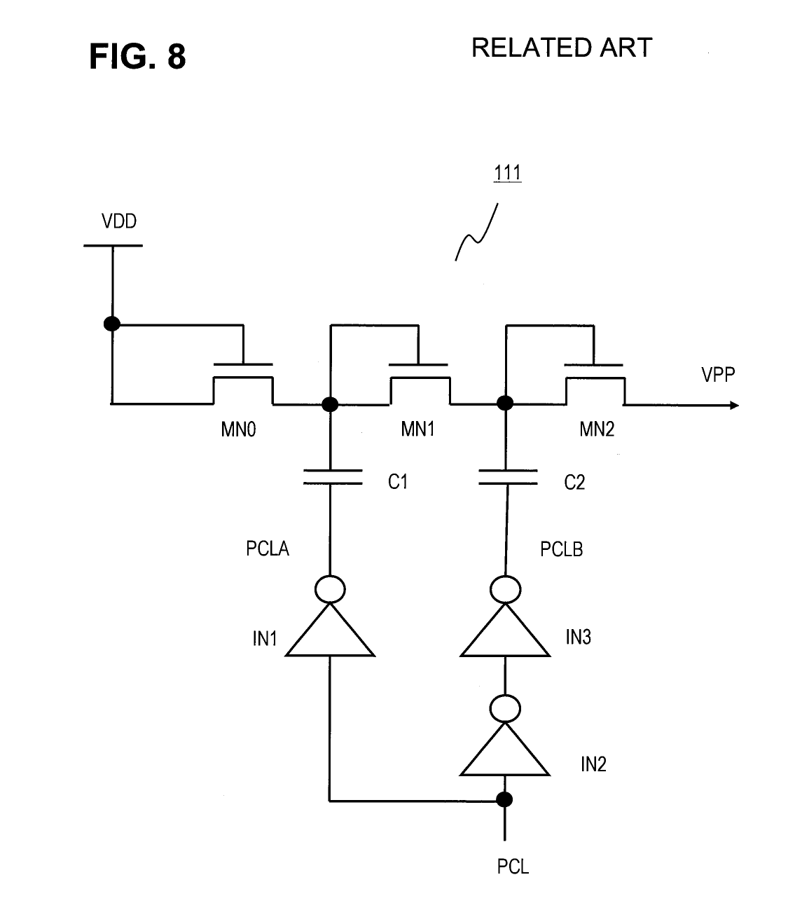

FIG. 2A is a characteristic diagram showing VPP current supply capability of the voltage booster circuits 11 and 12 making up the power supply circuit according to the present exemplary embodiment. A horizontal axis of FIG. 2A shows frequency of a clock supplied to the voltage booster circuits 11 and 12, and a vertical axis shows the VPP current supply capability of the voltage booster circuits 11 and 12. FIG. 2B shows consumption current in a case where the VPP is supplied to the DRAM 22, in a semiconductor device 20 shown in FIG. 6. A horizontal axis of FIG. 2B represents operating frequency of the DRAM 22, and a vertical axis represents the VPP current consumed by the DRAM 22.

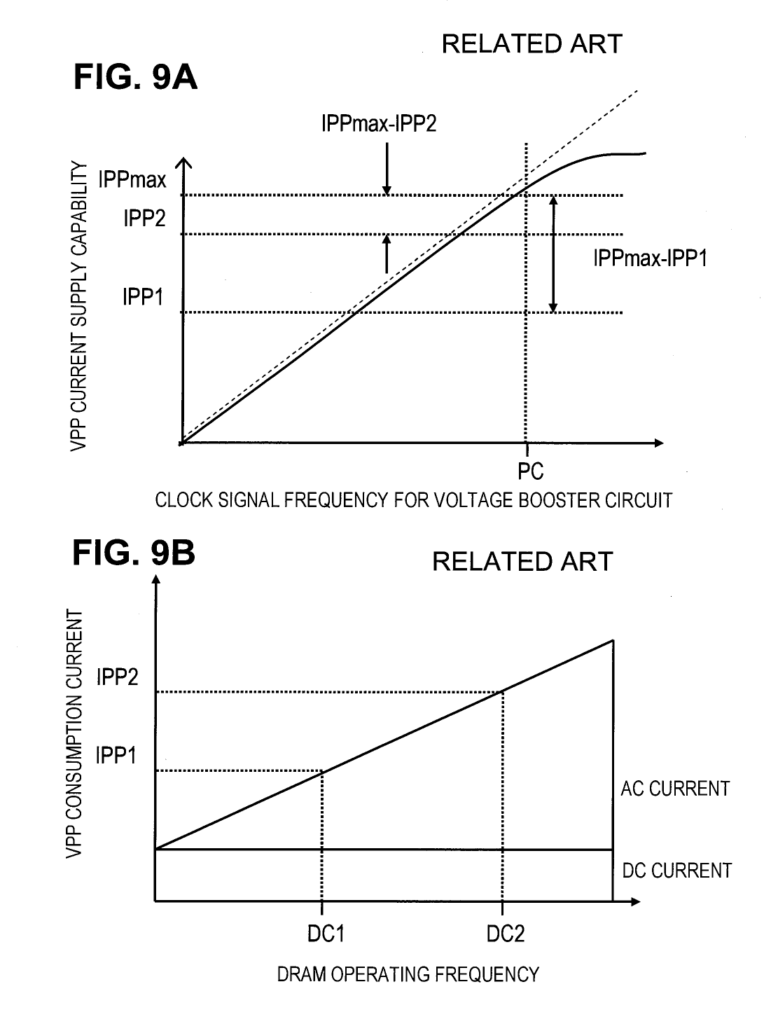

Similar to a case shown in FIG. 9A, for the voltage booster circuits 11 and 12 shown in FIG. 2A also, the current supply capability changes depending on clock signal frequency. The VPP consumption current in the DRAM 22 shown in FIG. 2B, similar to a case shown in FIG. 9B, includes a DC current component IPP0 and an AC current component. The AC current component is dependent on the operating frequency of the DRAM 22. Referring to FIG. 2B, the DRAM 22 consumes current of IPPA1 in a case of low frequency DC1, and consumes current of IPPA2 in a case of high frequency DC2.

The DC current component IPP0 does not depend on operating frequency of the DRAM 22. Furthermore, a fixed small current may be supplied as the DC current component IPP0. Therefore, the voltage booster circuit 12 that supplies the DC current component IPP0 can operate at a high frequency, and it is possible to make the size of this circuit small. Consequently, as shown in FIG. 2A, the voltage booster circuit 12 may operate at a fixed high frequency PC2, and may provide the DC current component IPP0.

On the other hand, the AC current component changes, depending on the operating frequency of the DRAM 22. Therefore, it is preferable that DC1 and DC2, which correspond to external clock frequencies in FIG. 2B, and clock signal frequencies PC1 and PC2 of the voltage booster circuit 11 in FIG. 2A, be in correspondence, and that the difference between the AC current components IPPA1 and IPPA2 corresponding to operating frequency of the DRAM 22, and the VPP current supply capability of the voltage booster circuit 11, which operates in synchronization with the external clock period, be made small.

At this time, if the operating frequency of the DRAM 22 changes in a range of from DC1 to DC2, the frequency of the clock signal with respect to the voltage booster circuit 11 also changes from PC1 to PC2 in synchronization with the external clock frequency. Therefore, the difference between the VPP consumption current of the DRAM 22 and the VPP current supply capability of the voltage booster circuit 11 can be made small in comparison to a conventional example shown in FIG. 9A.

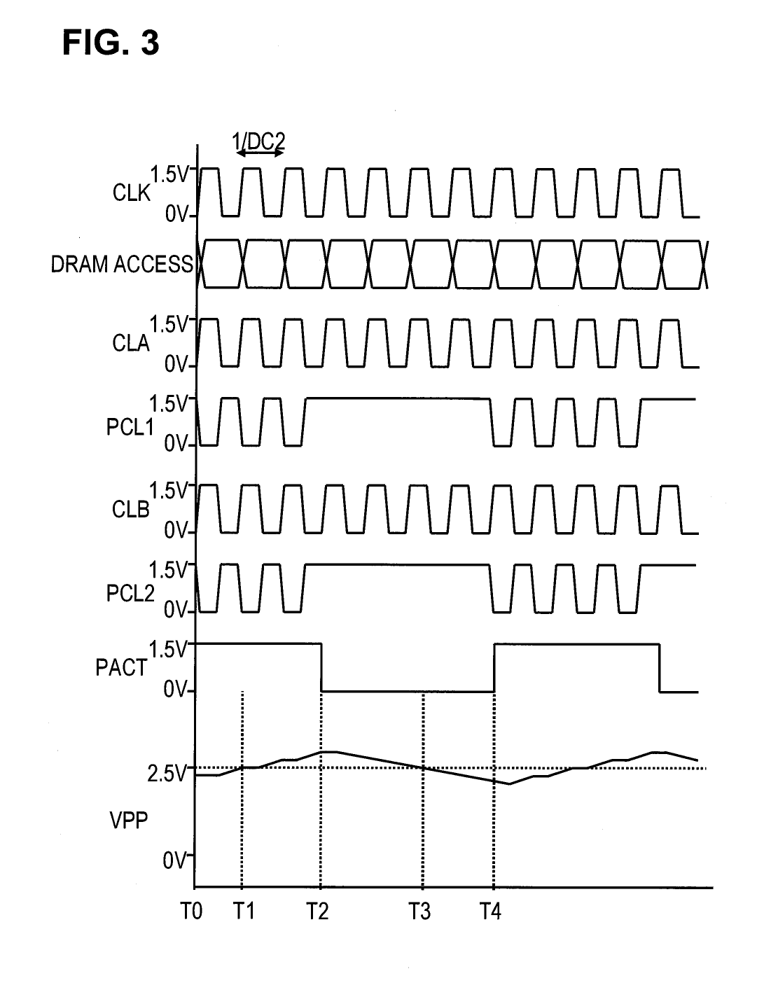

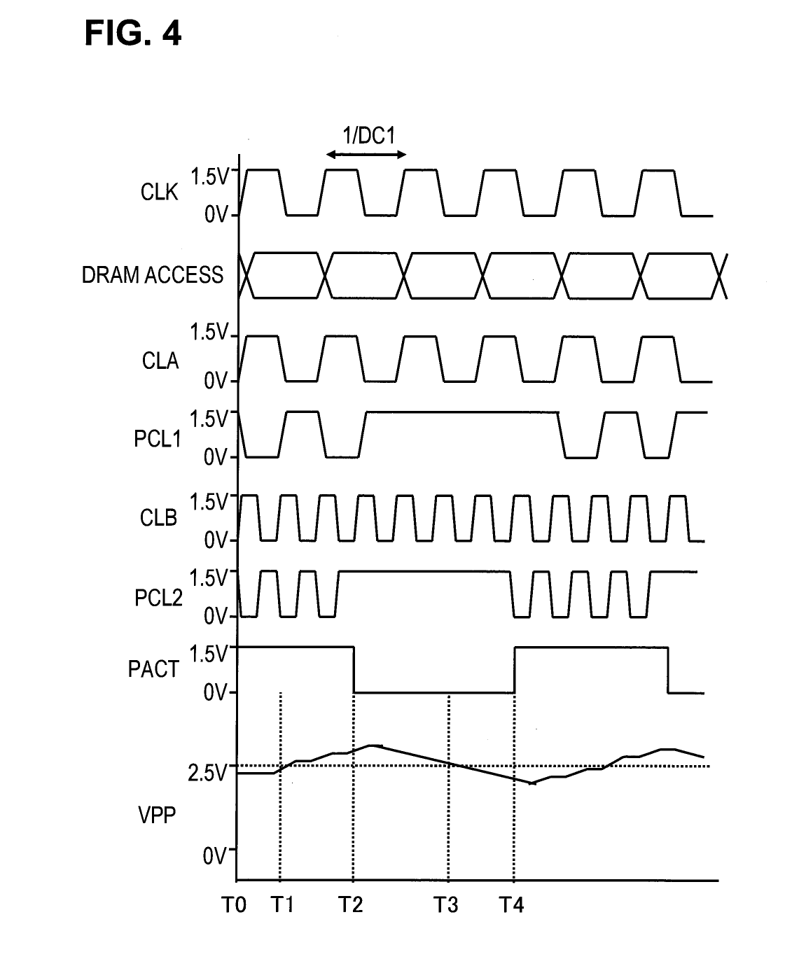

FIG. 3 and FIG. 4 are voltage waveform diagrams showing operation of the power supply circuit according to the present exemplary embodiment. Referring to FIG. 3 and FIG. 4, a description is given concerning operation of the power supply circuit according to the present exemplary embodiment.

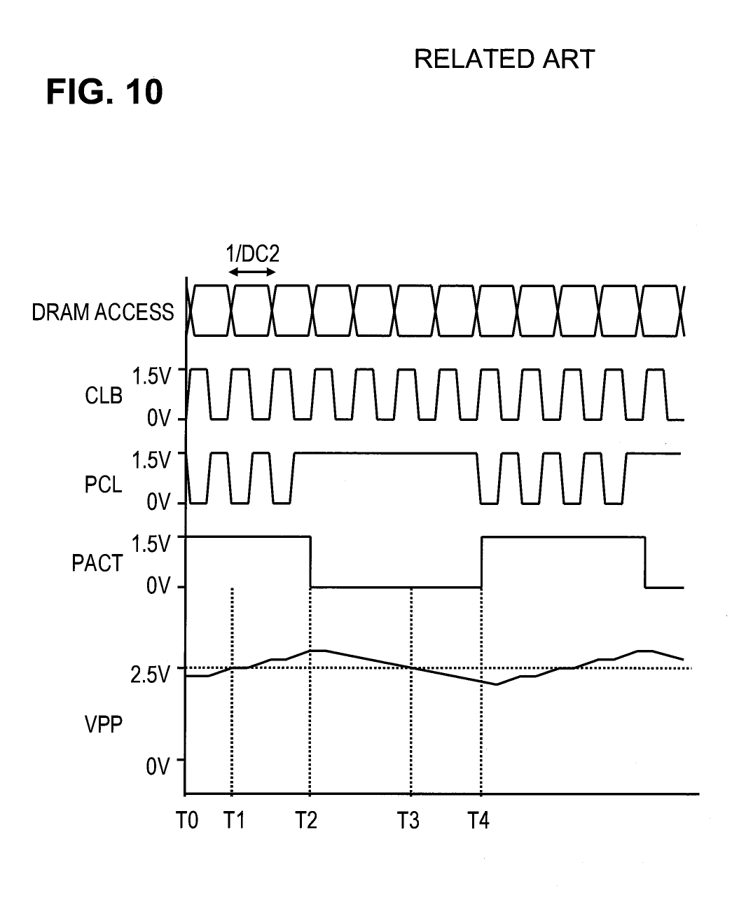

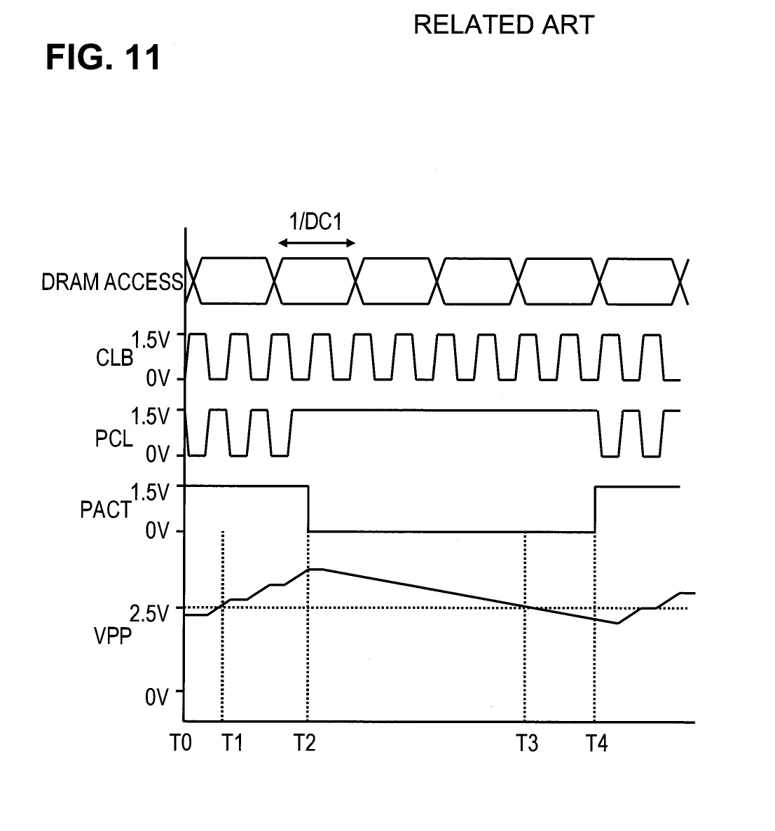

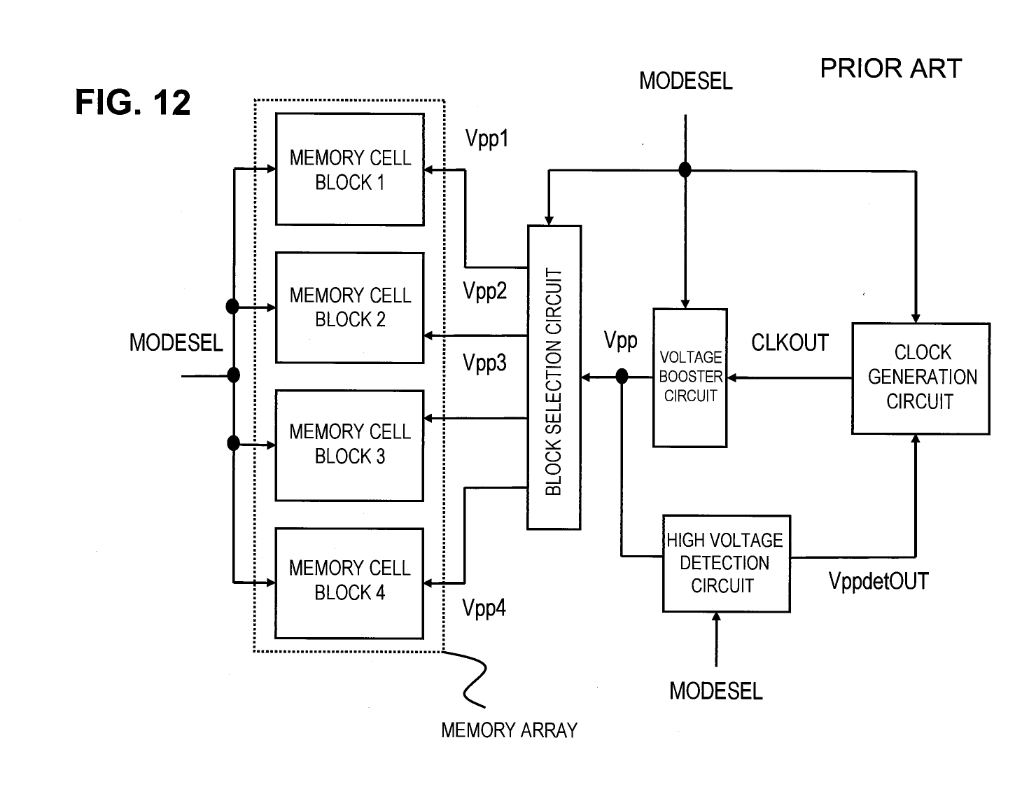

FIG. 3 and FIG. 4 correspond to operation of a conventional power supply circuit shown in FIG. 10 and FIG. 11, respectively. FIG. 3 shows operation of the power supply circuit in a case where the operating frequency of the DRAM 22 is a high frequency DC2. On the other hand, FIG. 4 shows operation of the power supply circuit in a case where the operating frequency of the DRAM 22 is a low frequency DC1.

Referring to FIG. 3, the external clock CLK is at a frequency DC2, and writing and reading of data from and to the DRAM 22 is performed at a cycle of frequency DC2.

The external clock input circuit 13 receives the external clock CLK, and supplies the clock signal CLA of frequency DC2, which is identical to the external clock CLK, to the voltage booster circuit 11.

On the other hand, the internal clock generation circuit 15 supplies the clock signal CLB of a fixed frequency not depending on the external CLK to the voltage booster circuit 12 (in FIG. 3, as an example, the frequency of the clock signal CLB is identical to DC2).

As an example, a set level of VPP is 2.5 V. Since at time T0 the VPP level is lower than a prescribed level, the output PACT of the high voltage detection circuit 16 is outputted at an H level. Since PACT is at the H level, the NAND circuit NAND1 supplies the clock signal PCL1 to the voltage booster circuit 11 in synchronization with the clock signal CLA (external clock CLK). In this way, the voltage booster circuit 11 performs a voltage boosting operation, and supplies a charge corresponding to the AC current component IPPA2 to the VPP. The NAND circuit NAND2 supplies the clock signal PCL2 to the voltage booster circuit 12 in synchronization with the clock signal CLB. In this way, the voltage booster circuit 12 performs a voltage boosting operation, and supplies a charge corresponding to the DC current component IPP0 to the VPP.

The level of the VPP gradually increases, and is 2.5 V at time T1. In consideration of delay time required for judgment of voltage by the high voltage detection circuit 16, the output PACT of the high voltage detection circuit transitions to an L level at time T2. Thereupon, the output PCL1 of the NAND circuit NAND1 and the output PCL2 of the NAND circuit NAND2 are fixed at the H level, and the voltage booster circuit 11 and the voltage booster circuit 12 stop the voltage boosting operation.

After this, the level of the VPP decreases due to operation of the DRAM 22, and after time T3 is less than 2.5 V. In consideration of the delay time required for judgment of voltage by the high voltage detection circuit 16, the output PACT of the high voltage detection circuit 16 transitions to an H level at time T4. Thereupon, similar to the case at time T0, the voltage booster circuit 11 and the voltage booster circuit 12 perform voltage boosting operations and supply a high voltage to the VPP.

By repeating the above operations, the VPP level is controlled to be in a vicinity of 2.5 V, which is a target value.

Referring to FIG. 4, the external clock CLK is at a frequency DC1, and writing and reading of data to and from the DRAM 22 is performed at a cycle of frequency DC1.

The external clock input circuit 13 receives the external clock CLK, and supplies the clock signal CLA of frequency DC1, which is identical to the external clock CLK, to the voltage booster circuit 11.

On the other hand, the internal clock generation circuit 15 supplies the clock signal CLB of a fixed frequency not depending on the external CLK to the voltage booster circuit 12 (in FIG. 4, as an example, the frequency of the clock signal CLB is identical to DC2).

Operation of the power supply circuit in this case is basically the same as for FIG. 3. However, by having the frequency of the clock signal PCL1 received by the voltage booster circuit 11 as the frequency DC1, which is equal to the external clock CLK, the voltage booster circuit 11 supplies a charge corresponding to the AC current component IPPA1 in the DRAM 22. Therefore, according to the power supply circuit of the present exemplary embodiment, it is possible to prevent excessively boosting voltage of the VPP in a time-period from time T1 to time T2, as in the conventional power supply circuit shown in FIG. 11, and control of a stable VPP becomes possible.

In the power supply circuit of the present exemplary embodiment, in a case where the external clock CLK stops, the voltage booster circuit 11 stops operation. However, since the internal clock generation circuit 15 continues to output the clock CLB, the DC current component (IPP0 in FIG. 2B) consumed by the DRAM 22 is continuously supplied by a boosting operation of the voltage booster circuit 12. Therefore, even in a time-period in which the external clock CLK stops, and writing and reading to and from the DRAM 22 are stopped, the level of the VPP is maintained at a prescribed level by the voltage booster circuit 12.

In the present exemplary embodiment, the consumption current of the high voltage VPP supplied by the power supply circuit is divided into a DC current component IPP0 that does not depend on an operation period of a supply destination circuit (for example, the DRAM 22), and an AC current component IPPA1 (or IPPA2) that depends on the operation period; the DC current component IPP0 is supplied by the voltage booster circuit 12 that operates by the clock signal (CLB) generated by the internal clock generation circuit 15; and the AC current component IPPA1 (or IPPA2) is supplied by the voltage booster circuit 11 that operates by the clock signal CLA in synchronization with the external clock CLK. In this way, the voltage booster circuit can supply a current corresponding to the consumption current of the supply destination circuit (for example, the DRAM 22). Therefore, even if the operating frequency of the supply destination (a DRAM part) changes, it is possible to stably control the high voltage VPP.

According to the power supply circuit of the present exemplary embodiment, it is possible to realize a power supply circuit having a suitable current supply capability that corresponds to consumption current (from IPPA1 to IPPA2 in the abovementioned example) that changes according to the external clock period, and it is possible to solve a problem in which voltage is excessively boosted in the VPP in a conventional power supply circuit.

That is, in the power supply circuit including the voltage booster circuit that generates high voltage as an internal power supply of the semiconductor device, by performing operation control of the voltage booster circuit corresponding to consumption current at high voltage, it is possible to prevent variations in control level of the high voltage due to change in the consumed current, and in particular, excessive voltage boosting. Furthermore, by preventing excessive voltage boosting, it is possible to prevent variations in circuit characteristic of a circuit supplied with the high voltage, and to prevent decrease in reliability.

### Second Exemplary Embodiment

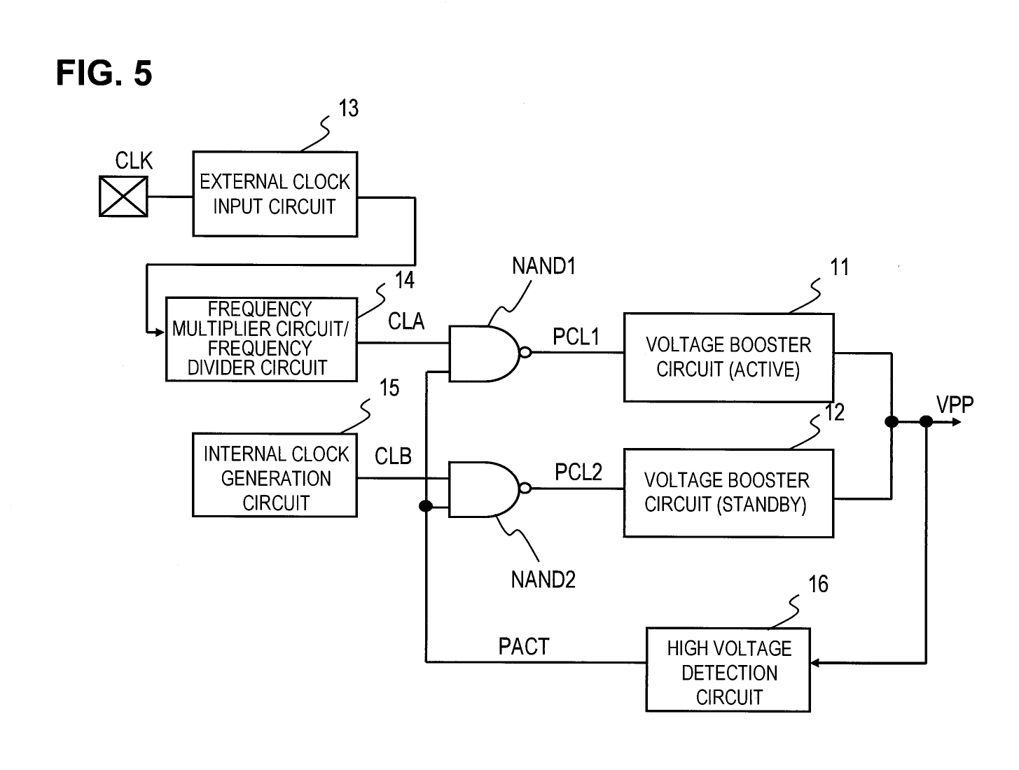

A description is given concerning a power supply circuit according to a second exemplary embodiment, making reference to the drawings. FIG. 5 is a block diagram showing a configuration of the power supply circuit according to the present exemplary embodiment. Referring to FIG. 5, the power supply circuit has voltage booster circuits 11 and 12, a high voltage detection circuit 16, an external clock input circuit 13, a frequency multiplier circuit (or a frequency divider circuit) 14, an internal clock generation circuit 15, and NAND circuits NAND1 and NAND2.

Referring to FIG. 5, the power supply circuit of the present exemplary embodiment has the frequency multiplier circuit (or the frequency divider circuit) 14. The external clock input circuit 13 receives an external clock CLK, and outputs to the frequency multiplier circuit (or the frequency divider circuit) 14. The frequency multiplier circuit (or the frequency divider circuit) 14 multiplies (or performs frequency division of) the received external clock CLK, and outputs a result as a clock signal CLA.

By providing the frequency multiplier circuit (or the frequency divider circuit) 14, the external clock CLK and the clock signal CLA supplied to the voltage booster circuit 11 change in synchronization, while maintaining an N times (or 1/N times) relationship. Here, N is a natural number.

According to the power supply circuit of the present exemplary embodiment, based on a frequency characteristic (FIG. 2A) of a VPP current supply capability of the voltage booster circuit, and a frequency characteristic (FIG. 2B) of a VPP consumption current of a DRAM 22, it is possible to perform adjustment so that a difference between the VPP consumption current of the DRAM 22 and the VPP current supply capability of the voltage booster circuit 11 becomes small.

The above description has been given based on the exemplary embodiments, but the present invention is not limited to the abovementioned exemplary embodiments.

Within the entire disclosure of the present invention (including the claims), and based on its basic technological idea, exemplary embodiments or examples of the present invention may be changed and/or adjusted. Also it should be noted that within the scope of the claims of the present invention, any combinations or selections of various elements disclosed herein are possible. That is, needless to say, it is understood by those skilled in the art that various changes or modifications can be made to the present invention based on the disclosure of the present invention including the claims and the technological idea of the present invention.

What is claimed is:

1. A power supply circuit comprising:
a first voltage booster circuit that receives a first clock signal having a fixed frequency, and supplies a voltage to a prescribed circuit; and
a second voltage booster circuit that receives a second clock signal having a frequency corresponding to an operating frequency of said prescribed circuit, and supplies a voltage to said prescribed circuit.

2. The power supply circuit according to claim 1, further comprising a high voltage detection circuit that detects a voltage supplied to said prescribed circuit by said first voltage booster circuit and said second voltage booster circuit, and in a case where said voltage is larger than a prescribed threshold voltage, stops a voltage boosting operation in said first voltage booster circuit and said second voltage booster circuit.

3. The power supply circuit according to claim 1, further comprising an internal clock generation circuit that generates said first clock signal.

4. The power supply circuit according to claim 2, further comprising an internal clock generation circuit that generates said first clock signal.

5. The power supply circuit according to claim 1, wherein
said first voltage booster circuit outputs a direct current component in current consumed by said prescribed circuit, and
said second voltage booster circuit outputs an alternating current component in current consumed by said prescribed circuit.

6. The power supply circuit according to claim 2, wherein
said first voltage booster circuit outputs a direct current component in current consumed by said prescribed circuit, and
said second voltage booster circuit outputs an alternating current component in current consumed by said prescribed circuit.

7. The power supply circuit according to claim 3, wherein
said first voltage booster circuit outputs a direct current component in current consumed by said prescribed circuit, and
said second voltage booster circuit outputs an alternating current component in current consumed by said prescribed circuit.

8. The power supply circuit according to claim 1, further comprising: a frequency multiplier circuit that receives a clock signal having an operating frequency of said prescribed circuit, and multiplies said frequency, which is outputted as said second clock signal.

9. The power supply circuit according to claim 2, further comprising: a frequency multiplier circuit that receives a clock signal having an operating frequency of said prescribed circuit, and multiplies said frequency, which is outputted as said second clock signal.

10. The power supply circuit according to claim 3, further comprising: a frequency multiplier circuit that receives a clock signal having an operating frequency of said prescribed circuit, and multiplies said frequency, which is outputted as said second clock signal.

11. The power supply circuit according to claim 4, further comprising: a frequency multiplier circuit that receives a clock signal having an operating frequency of said prescribed circuit, and multiplies said frequency, which is outputted as said second clock signal.

12. The power supply circuit according to claim 1, further comprising: a frequency divider circuit that receives a clock signal having an operating frequency of said prescribed circuit, and performs frequency division of said frequency, which is outputted as said second clock signal.

13. The power supply circuit according to claim 2, further comprising: a frequency divider circuit that receives a clock signal having an operating frequency of said prescribed circuit, and performs frequency division of said frequency, which is outputted as said second clock signal.

14. The power supply circuit according to claim 3, further comprising: a frequency divider circuit that receives a clock signal having an operating frequency of said prescribed circuit, and performs frequency division of said frequency, which is outputted as said second clock signal.

15. The power supply circuit according to claim 4, further comprising: a frequency divider circuit that receives a clock signal having an operating frequency of said prescribed circuit, and performs frequency division of said frequency, which is outputted as said second clock signal.

16. The power supply circuit according to claim 5, further comprising: a frequency divider circuit that receives a clock signal having an operating frequency of said prescribed circuit, and performs frequency division of said frequency, which is outputted as said second clock signal.

17. A semiconductor device comprising said power supply circuit according to claim 1.

18. The semiconductor device according to claim 17, further comprising said prescribed circuit.
